(19) United States
(12) Patent Application Publication
(10) Pub. No.: US 2012/0167319 A1
(43) Pub. Date: Jul. 5, 2012

(54) WET FRICTION MATERIAL FOR ORAL CARE DEVICES

(76) Inventors: Steven Francis Quigley, Kennebunkport, ME (US); Chandrasen Gajria, Hingham, MA (US)

(21) Appl. No.: 13/331,443

(22) Filed: Dec. 20, 2011

Related U.S. Application Data
(60) Provisional application No. 61/429,817, filed on Jan. 5, 2011.

(51) Int. Cl. A46B 9/04; B29C 45/00; A46B 15/00

(52) U.S. Cl. 15/110; 15/167.1; 264/328.1

(57) ABSTRACT

An oral care device having a thermoplastic elastomer disposed on a portion of the oral care device and one or more projections extending from the thermoplastic elastomer. The thermoplastic elastomer is polar and hydrophilic.

### CROSS REFERENCE TO RELATED APPLICATION(S)

This patent application claims priority to U.S. Provisional Application No. 61/429,817, filed Jan. 5, 2011.

### FIELD OF THE INVENTION

The invention generally relates to wet friction materials for oral care devices, more particularly to materials for cleaning any part of the oral cavity in which the materials have a high coefficient of friction when wet.

### BACKGROUND OF THE INVENTION

Oral care devices typically include thermoplastic polymers to engage a surface of a user. For example, bristles of a toothbrush or grip portions on a handle of an oral care device include thermoplastic polymers to improve engagement of a user's surface with the oral care device. Known thermoplastic polymers for oral care devices, however, may be slippery when the devices are wet during typical oral care environments. This results in slippage and/or poor engagement of the thermoplastic polymer with a user's surface. In addition, with respect to grip portions of oral care devices, users often have to apply extra effort to grip the devices.

Current approaches may increase the coefficient of friction when wet, but these approaches, however, do not improve a user's perception of gripping the oral care devices or engaging a user's surface with the thermoplastic polymers. For example, in one approach, the thermoplastic polymer can have a higher coefficient of friction, but such approaches may also have higher tack or perception of stickiness to a user, which may be uncomfortable and undesirable. In addition, current approaches have issues manufacturing thermoplastic polymers that adhere to substrates of oral care devices, such as for injection molded thermoplastic elastomers adhering to substrates of oral care devices.

What is needed, then, is a wet friction material suitable for an oral care device that preferably is stable and durable, and has a high coefficient of friction when wet and low tack when dry, which would improve engagement of the oral care device with a user's surface, e.g., for secure grip of a handle portion, potentially without discomfort. What is also needed is a wet friction material that can preferably adhere to a substrate of an oral care device for injection molded polymers, such as injection molded thermoplastic elastomers.

### SUMMARY OF THE INVENTION

In one aspect, the invention relates to an oral care device comprising a thermoplastic elastomer disposed on a portion of the oral care device and one or more projections extending from the thermoplastic elastomer. The thermoplastic elastomer is polar and hydrophilic.

The foregoing aspect can comprise one or more of the following embodiments. The thermoplastic elastomer can have a coefficient of friction of in a range of about 2.0 to about 3.5 when wet with water, a tack force of about 3 g to about 12 g, and/or a Shore A hardness of about 35 to about 50. The one or more projections can comprise at least two projections, and/or at least one groove can be formed between the at least two projections. The one or more projections can be integrally formed with the thermoplastic elastomer, for example, by injection molding, as another example, by two-step injection molding. The portion of the oral care device comprises at least one of a grip portion of the oral care device, a head portion of the oral care device, a cleaning portion of the oral care device, and/or a massaging portion of the oral care device. The grip portion comprises a thumb rest portion, an index ringer rest portion, and/or a third portion. The thermoplastic elastomer can be combined with a non-elastomer.

In another aspect, the invention relates to an oral care device comprising a thermoplastic elastomer disposed on at least a portion of the oral care device and the thermoplastic elastomer defining one or more pores to facilitate removal of water when wet. The thermoplastic elastomer is polar and hydrophilic.

This aspect can comprise one or more of the following embodiments. The thermoplastic elastomer can have a coefficient of friction of in a range of about 2.0 to about 3.5 when wet with water, a tack force of about 3 g to about 12 g, and/or a Shore A hardness of about 35 to about 50. The oral care device can also comprise one or more projections extending from the thermoplastic elastomer, and/or at least one groove can be formed between at least two projections. The one or more projections can be integrally formed with the thermoplastic elastomer, for example, by injection molding, as another example, by two-step injection molding. The portion of the oral care device can comprise at least one of a grip portion of the oral care device, a head portion of the oral care device, a cleaning portion of the oral care device, and/or a massaging portion of the oral care device. The grip portion comprises a thumb rest portion, an index ringer rest portion, and/or a third portion. The thermoplastic elastomer can be combined with a non-elastomer.

### BRIEF DESCRIPTION OF THE DRAWINGS

Other features and advantages of the present invention, as well as the invention itself, can be more fully understood from the following description of the various embodiments, when read together with the accompanying drawings, in which:

FIG. 1 is a schematic front view of a known oral care device;

FIG. 2 is a schematic perspective view of a known oral care device when wet;

FIG. 3 is a schematic perspective view of a wet friction material when wet, in accordance with an embodiment of the invention;

FIG. 4 is a chart illustrating the coefficient of friction of a wet friction material according to an embodiment of the invention when wet;

FIG. 5 is a chart illustrating properties of tack and coefficient of friction when wet for a wet friction material according to an embodiment of the invention;

FIG. 6 is a schematic perspective view of a textured surface in accordance with an embodiment of the invention;

FIG. 7 is a schematic perspective view of another textured surface in accordance with an embodiment of the invention;

FIG. 8 is a schematic perspective view of yet another textured surface in accordance with an embodiment of the invention; and

FIG. 9 is a schematic perspective view of still another textured surface according to an embodiment of the invention.

### DETAILED DESCRIPTION OF THE INVENTION

Except as otherwise noted, the articles “a,” “an,” and “the” mean “one or more.”

As used herein, “surface” in the context of surface-engaging comprises skin and any part or portion of the oral cavity, such as a tooth, gums, tongue, inside walls of the cheeks, and inside roof of the mouth.

As used herein, “oral care devices” comprise any apparatus or device intended for use in the oral cavity, such as a toothbrush (manual or electric), floss, tongue cleaner, gum massager/cleaner, and combinations thereof. Nonlimiting examples of oral care devices are described in PCT Publication Nos. WO 97/016995; WO 98/18364; WO 99/001054; WO 01/45573; WO 02/11583; WO 05/009274; WO 05/023144; WO 05/063143; WO 08/090,529; and WO 10/059,484; U.S. Pat. Nos. 5,755,243; 6,151,745; 6,372,162; 6,475,553; 6,905,673; 6,993,804; 7,475,553; and 7,748,070.

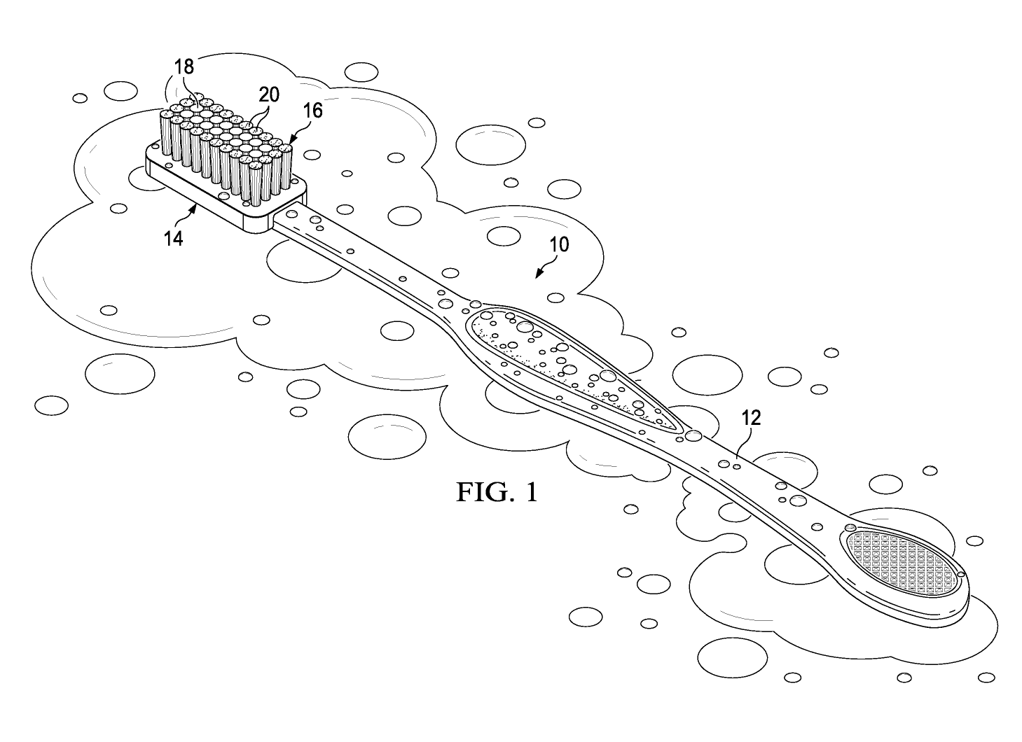

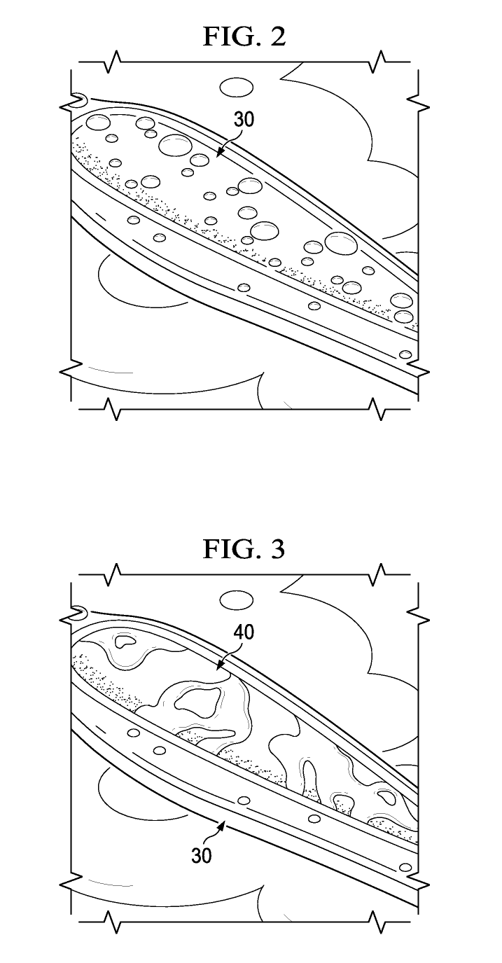

Referring to FIGS. 1 and 2, a known oral care device 10 includes a plastic body having a handle 12 and a head 14 attached to a bristle portion 16. The handle 12 is shaped to be grasped by a hand, but, alternatively, can be shaped to fit into an electric toothbrush. Brush portion 16 includes one or more non-elastomeric bristles 18 and a number of thermoplastic elastomeric bristles 20.

The configuration of the head 14 can vary and may be rectangular, oval, diamond-shaped, or any other shape, with bristles that are trimmed flat, serrated, v-shaped, convex curved, or any other desired topography. The shape and size of handle 12 and head 14 can vary and the axes of the handle 12 and head 14 may be on the same or a different plane. A larger head 14 may be provided in order to provide extra room for the thermoplastic elastomer bristles 20, while, additionally or alternatively, still retaining some non-elastomeric bristles 18.

A portion 30 of the oral care device 10, such as the handle 12, the head 14, the bristle portion 15, and/or a tongue cleaner may have low surface energy and/or hydrophobic properties such that water on the portion 30 beads up when the toothbrush 10 is wet. Any portion of or all of the toothbrush 10 can be made from thermoplastic polymers, such as polyolefins, polyethylene, and polypropylene. Nonlimiting examples of oral care devices with thermoplastic polymers are described in PCT Publication Nos. WO 97/016995; WO 98/18364; WO 99/001054; WO 01/45573; WO 02/11583; WO 05/009274; WO 05/023144; WO 05/063143; WO 08/090,529; and WO 10/059,484; U.S. Pat. Nos. 5,755,243; 6,151,745; 6,372,162; 6,475,553; 6,905,673; 6,993,804; 7,475,553; and 7,748,070.

Referring now to FIG. 3, a wet friction material 40 is disposed on the portion 30 of the oral care device 10. Additionally or alternatively, the wet friction material 40 is disposed on, formed on, and/or formed with the body, the handle 12, the head 14, the bristle portion 16, and/or the tongue cleaner of the oral care device 10. The wet friction material 40 can be included on or with any surface-engaging portion of the oral care device 10. For example, the wet friction material 40 is disposed on a substrate of the oral care device 10 in which the substrate can be formed from a variety of materials, such as polymers (e.g., thermoplastic polymers, polypropylene, polyethylene, etc.), plastic, metal (e.g., diecast metal), etc. In an embodiment, wet friction material 40 can be combined with non-elastomers. Nonlimiting examples of elastomeric materials combined with non-elastomers are described in PCT Publication No. WO 05/009274. For example, wet friction material 40 is preferably injection molded and optionally molded with the substrate in a two-stage injection molded process, for example, in embodiments in which the substrate is optionally a thermoplastic polymer, such as a thermoplastic elastomer. Nonlimiting examples of injection molded processes for oral care devices are described in U.S. Pat. No. 6,372,162.

In alternative embodiments, wet friction material 40 can be disposed on, formed on, and/or formed with any portion of an oral care device. For example, wet friction material 40 can coat, be disposed on, formed on, and/or formed with at least a head portion; at least a cleaning portion; at least a massaging portion; at least a portion of floss; at least a portion of bristles on a toothbrush; at least a portion of projections on a side or back of a toothbrush head, such as a gum stimulator and/or a tongue cleaner; and/or at least a portion of a grip portion, such as a handle, or a toothbrush (manual or electric). Where wet friction material 40 is disposed on, formed on, and/or formed with at least a portion of a handle, the portion of the handle can include a thumb rest portion, the index finger rest portion, such as on the back of the handle, and/or any other portion of the handle.

The wet friction material 40 has a high coefficient of friction when wet, e.g., higher coefficient of friction when wet compared to known thermoplastic polymers for oral care devices. The coefficient of friction is high for the wet friction material 40 when wet in aqueous environments, including water and lubricious materials (e.g., toothpaste, saliva, etc.). Furthermore, the wet friction material 40 may have a higher surface compliance than that of the known thermoplastic polymer for oral care devices, but preferably with low tack. For example, users can securely grip the wet friction material 50, e.g., resulting in improved comfort and control, when wet and not be uncomfortably grippy or sticky when dry. In an embodiment, the wet friction material 40 is polar and hydrophilic. Additionally or alternatively, the wet friction material 40 has high surface energy (e.g., perhaps via a sufficiently low contact angle) so that wettability of the wet friction material 40 is improved and so that water beads are minimized or non-existent when the wet friction material 40 is wet with water. Without intending to be bound by any theory, it is believed that preventing water (or other lubricious materials) from beading and improving wettability (e.g., promoting surfacing wetting) may each or both serve to thin the amount of water that a user must penetrate to engage the skin to the wet friction material 40.

The wet friction material 40 comprises a polymer, preferably a thermoplastic polymer, and even more preferably a thermoplastic elastomer. Nonlimiting examples of suitable thermoplastic elastomers are described in U.S. Pat. Nos. 5,314,940, 5,670,263, 6,610,382, and 6,904,615; U.S. Patent Application Publication Nos. 2002/0114920 and 2011/0143112. For example, suitable classes of elastomers may comprise hydrated styrene block copolymers (e.g., styrene-ethylene-butylene (SEBS) and styrene-butadiene-styrene (SBS)), anionic triblock copolymers, polyolefin-based thermoplastic elastomers, thermoplastic elastomers based on halogen-containing polyolefins, thermoplastic elastomers based on dynamically vulcanized elastomer-thermoplastic blends, thermoplastic polyether ester or polyester based elastomers, thermoplastic elastomers based on polyamides or polyimides, ionomeric thermoplastic elastomers, partially or fully hydrogenated styrene-butadiene-styrene block copolymers, hydrogenated block copolymers in thermoplastic elastomer interpenetrating polymer networks, thermoplastic elastomers by carbocationic polymerization, polymer blends containing styrene/hydrogenated butadiene block copolymers, block polymers such as polystyrene materials with elastomeric segments, and polyacrylate-based thermoplastic elastomers. Examples of elastomers may include natural rubber, butyl rubber, EPDM rubber, silicone rubber such as polydimethyl siloxane, polyisoprene, polypropylene, polybutadiene, polyurethane, ethylene/propylene/diene terpolymer elastomers, chloroprene rubber, styrene-butadiene copolymers (random or block), styrene-isoprene copolymers (random or block), acrylonitrile-butadiene copolymers, mixtures thereof and copolymers thereof. The block copolymers may be linear, radial or star configurations and may be diblock (AB) or triblock (ABA) copolymers or mixtures thereof. Blends or combinations of these elastomers with each other or with modifying non-elastomers are also contemplated. Elastomers may be available from Arkema Inc., Philadelphia, Pa. (e.g., Pebax® 2533); E. I. duPont de Nemours & Co., Wilmington, Del. (e.g., Zytel® 158L); Kraiburg TPE Corp., Duluth, Ga.; and Kraton Polymers U.S. LLC, Houston, Tex.

Additionally or alternatively, the wet friction material 40 is a composite structure, such as a thermoplastic elastomer modified with additives, fillers, and/or rubber mixtures or modifiers. Suitable composite structures, additives, and/or fillers are described in U.S. Pat. No. 3,972,528. For examples, additives may be one or more of the following additives: paraffinic white oils, inorganic bulking agents, ether ester plasticizers, sulfurized mineral oil, alkenyl amide, styrol, polystyrol, petrolatum, polyisobutylene, polybutene, styrene, elastomeric styrene, ethylene, butylene, aqueous carboxylated synthetic polymer having a minimum film-forming temperature (MFFT) (e.g., 10 degrees Celsius or below), low MFFT synthetic polymer reinforced during manufacturing by co-agglomeration with polystyrene, combinations thereof, or any other suitable additive to achieve a wet friction material 50 that has a high coefficient of friction when wet and low tack when dry. Additionally or alternatively, fillers may be one or more if the following fillers: clay treated with lignin sulfonate, pulverized fragments of foamed melamine resin, porous granulated aluminum oxide powder, diatomaceous earth, silica, acrylonitrile pulp, granular filler having a surface area of about 35 m²/g to about 410 m²/g, clay (about 5 parts by weight to about 30 parts by weight), aluminum hydroxide, hollow aluminum oxide particle, dibutylphtalate (applied on carbon fiber base material) that has been hardened, fired, and carbonized), vulcanized rubber particles, aramid fiber, waste ash, ethylene vinyl acetate, polyethelyene, rubber, elastomer, hollow carbonate, alumina, carbide, carborundum, diamond powder, white carbon (about 15 percentage by weight to about 80 percentage by weight), ceramic fiber (about 5 percentage by weight to about 50 percentage by weight), combinations thereof, or any other suitable filler to achieve a wet friction material 50 that has a high coefficient of friction when wet and low tack when dry. The quantity of any additives and/or fillers is controlled such that tensile strength is maintained at an acceptable level with adhesion to a substrate also being maintained at an acceptable level.

Additionally or alternatively, where an oral care device 10 has more than one portion having wet friction material, each of the portions can have different embodiments of wet friction materials. Moreover, a wet friction material can be combined with non-elastomers.

For those embodiments where the portion, e.g., 30 and/or 40, are in the head 14 of the oral care device 10, a variety of options exist. The elastomeric material may be utilized for surface-engaging elements which can be positioned in any suitable location. As shown in FIG. 1, the elastomeric bristles 20 may be positioned adjacent a periphery of the head 14. In some embodiments, the elastomeric bristles 20 may be positioned inboard of the periphery adjacent a longitudinal axis of the head 14. In some embodiments, an oral care device may comprise a combination of elastomeric bristles, a portion of which are disposed adjacent the periphery and a portion of which are disposed inboard of the periphery.

The elastomeric surface-engaging elements may comprise any suitable shape. For example, the elastomeric bristles may be shaped as bristle filaments in a bristle tuft, straight walls, curved walls, continuous wall shapes, e.g., cups, discontinuous wall shapes, intersecting walls, and/or the like. Some suitable examples of shapes which may be utilized are provided in U.S. Patent Application Publication No. 2009/0282628A1. Additional suitable examples of elastomeric surface-engaging elements are described in U.S. Patent Application Publication Nos. 2007/0251040; 2004/0154112; and 2006/0272112; and U.S. Pat. Nos. 6,553,604 and 6,151,745. The cleaning portions may be tapered, notched, crimped, dimpled, or the like. Some suitable examples of these surface-engaging elements and/or massaging elements are described in U.S. Pat. Nos. 6,151,745; 6,058,541; 5,268,005; 5,313,909; 4,802,255; 6,018,840; 5,836,769; 5,722,106; and 6,475,553; and U.S. Patent Application Publication No. 2006/0080794.

The elastomeric surface-engaging elements may be attached to the head 14 of the oral care device 10 in any suitable manner As one example, the head 14 may comprise openings into which the elastomeric surface-engaging elements are injection molded. In such embodiments, the material for the elastomeric surface-engaging elements may be injection molded from a backside of the head 14 to a front side in order to form the elastomeric surface-engaging elements. As another example, the head 14 may comprise scalloped shaped edges as described in U.S. Pat. No. 6,886,207. As another example, the elastomeric surface-engaging elements or a portion thereof may be attached to the head 14 such that one or more of the elastomeric surface-engaging elements pivot as described in U.S. Pat. No. 6,553,604; U.S. Patent Application Publication No. 2007/0251040A1; and U.S. Patent Application Publication No. 2010/0162499A1.

Additionally, the oral care device 10 may comprise a tongue cleaner on a backside surface-engaging element such as via through holes in the head 14 or scallops on the side of the head 14. The tongue cleaner may be separately injection molded from the elastomeric surface-engaging elements. The tongue cleaner may comprise the material utilized for the elastomeric bristles. The tongue cleaner may be configured in any suitable manner. Some examples are described in U.S. Patent Application Nos. 2006/0010628; 2005/0166344; 2005/0210612; 2006/0195995; 2008/0189888; 2006/0052806; 2004/0255416; 2005/0000049; 2005/0038461; 2004/0134007; 2006/0026784; 20070049956; 2008/0244849; 2005/0000043; and 2007/140959; and U.S. Pat. Nos. 5,980,542; 6,402,768; and 6,102,923.

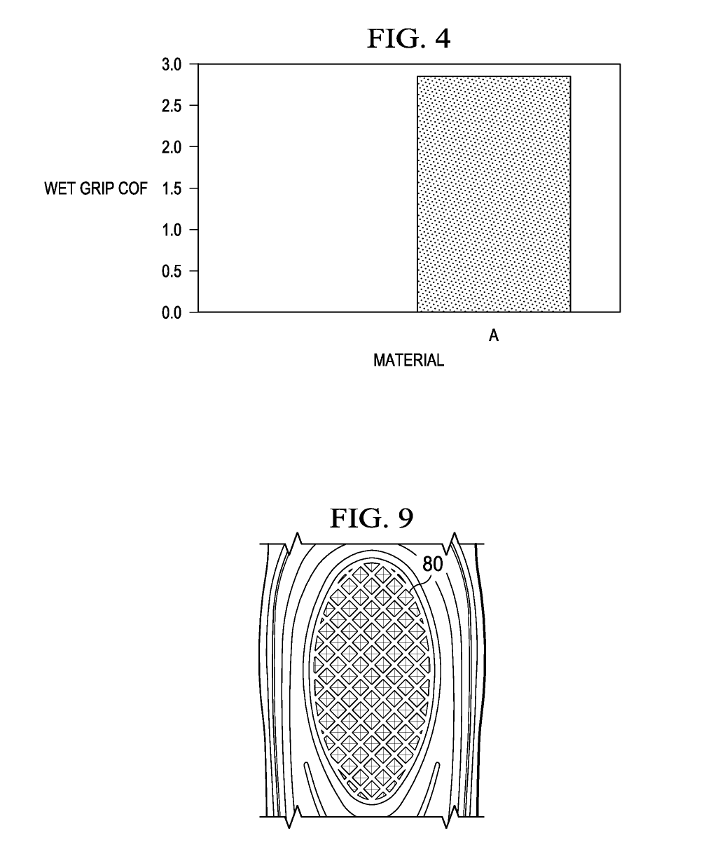

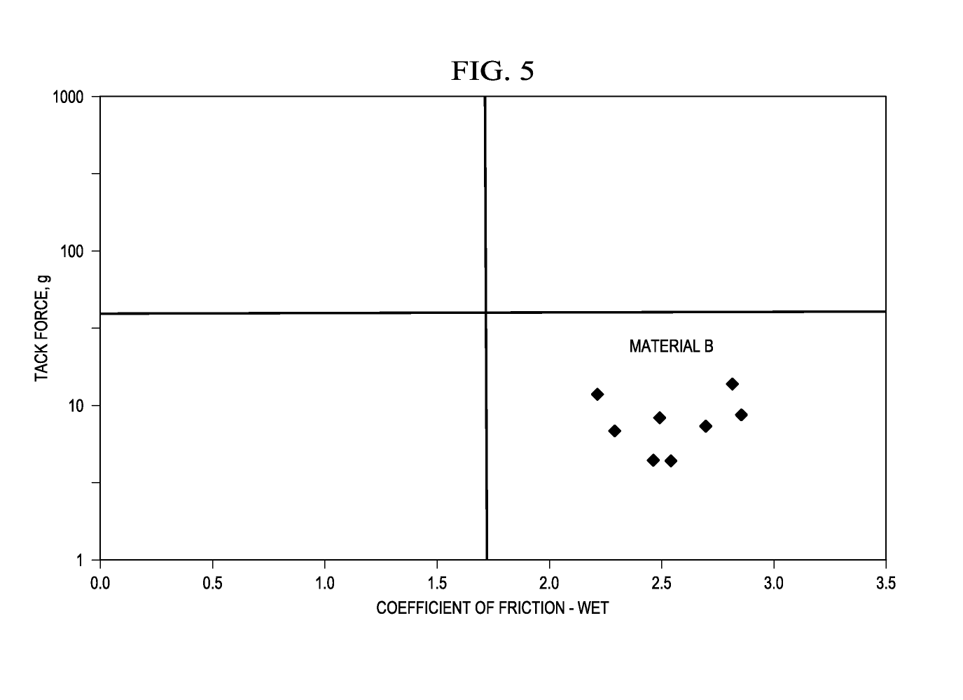

FIGS. 4 and 5 illustrate various properties, such as coefficient of friction when wet and tack force when dry, wet friction materials A and B. Tack is a characteristic of a material to form an immediate cohesive adherence to a contacting surface. Therefore, tack form is the measure of resistance of the material to separate from the contacting surface. In an embodiment, wet friction material A has a coefficient of friction when wet with water of about 2.8. The tack force of the wet friction material B can be similar to that of known thermoplastic polymers, though the tack force of wet friction materials can be greater than or lesser than the known thermoplastic polymers. The tack force of the wet friction material B is in a range of about 1 g to about 25 g, preferably about 3 g to about 12 g. In alternative embodiments, the tack force of a wet friction material in accordance with an embodiment of the invention can be much higher than that of the known thermoplastic polymers. For example, the tack force of a wet friction material can be in a range of about 200 g to about 700 g, preferably about 300 g to about 500 g. The coefficient of friction when wet with water for the wet friction material B is preferably in a range of about 2.1 to about 3.2, and even more preferably about 2.4 to about 2.8. The coefficient of friction when wet with lubricious material, for example, wet friction materials according to embodiments of the invention can be in a range of about 0.28 to about 2.0, and preferably about 0.29 to about 0.5.

Generally, wet friction materials of the invention have a higher coefficient of friction when dry, higher coefficient of friction when wet, and higher surface energy. Additionally or alternatively, the hardness of a wet friction material can be in a range of Shore A hardness of about 5 to about 95, preferably about 30 to about 60, and even more preferably about 35 to about 53. The coefficient of friction when dry for wet friction materials can be in a range of about 2.0 to about 5.3, preferably about 2.4 to about 3.0. The coefficient of friction when wet with water for wet friction materials can be in a range of about 1.4 to about 5.0, preferably about 1.9 to about 2.8. Surface energies of wet friction materials can be in a range of about 25 mJ/m² to about 52 mJ/m², preferably about 27 mJ/m² to about 34 mJ/m².

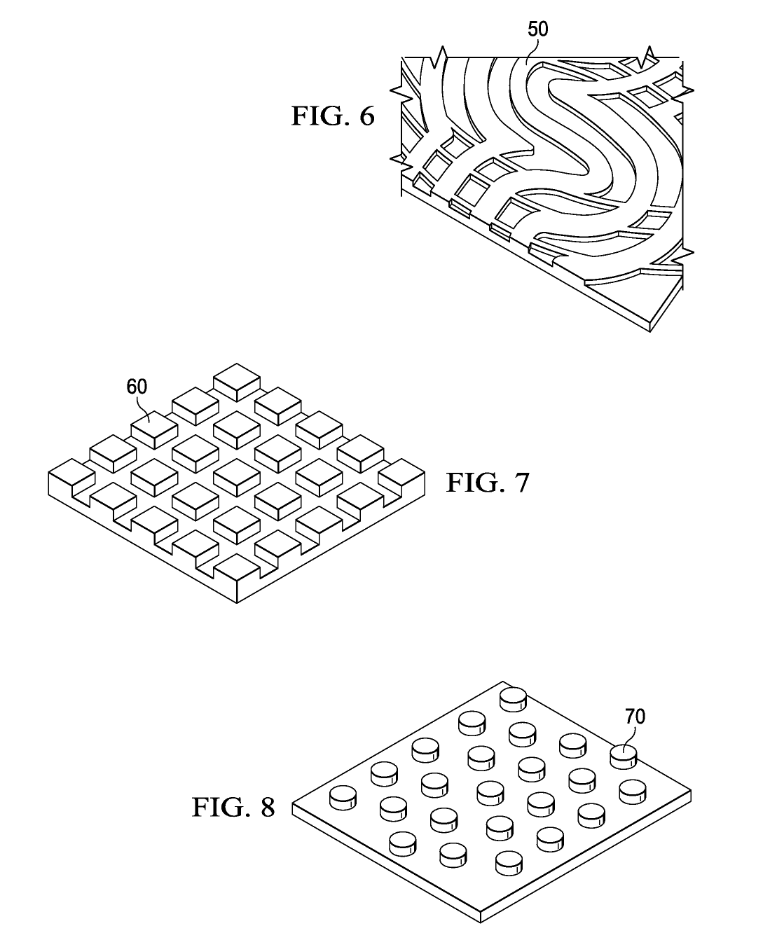

Referring now to FIGS. 6 through 9, various embodiments of wet friction materials of the present invention can optionally include projections or textured patterns extending from the wet friction material to improve engagement of the wet friction material with a skin The projections and textured patterns can also break the surface tension of the water (or lubricious material) or be exposed above the water (or lubricious material) for engagement with skin or a portion of the oral cavity. In one embodiment, a textured pattern 50 can be similar to that of a fingerprint pattern with nonlinear shapes, concave and/or convex curvatures, and intersecting lines. In another embodiment, projections 60 can have a generally rectangular shape, such that a cross-section of each of the projections 60 is generally square. By “generally rectangular” the projections 60 include non-rectangular elements, e.g., ridges, protrusions, or recesses, and/or may include regions along its length that are not rectangular, such as tapered and/or flared ends due to manufacturing and design considerations. In yet another embodiment, projections 70 can be generally cylindrical, such that a cross section of the each of the projections 70 can be generally circular. By “generally cylindrical” the projections 70 include non-cylindrical elements, e.g., ridges, protrusions, or recesses, and/or may include regions along its length that are not cylindrical, such as tapered and/or flared ends due to manufacturing and design considerations. In still another embodiment, projections 80 can be generally knurled, such that a cross-section of each of the projections 80 can be generally diamond-shaped. The projections can form any geometric, polygonal, arcuate shape, or combinations thereof. For example, the projections can include a combination of a knurled pattern and arcuate ridges. In an embodiment, the projections and/or the textured patterns are integrally formed with the wet friction material. Additionally or alternatively, the projections and/or textured patterns can be configured and shaped to form channels for fluid removal. The channels can be grooves formed between the projections. In an additional or alternative embodiment, the channels can define pores to remove/wick fluid away from the wet friction material by absorbing fluids, e.g., via an absorbent layer beneath the wet friction material, or by allowing the fluid to drain underneath the wet friction material. In various embodiments, without intending to be bound by any theory, it is believed that a range of percentage ratios of the distance between projections (D) over the height of the projections (H) promote pleasant sensory touch, preferably in a range of about 25% to about 75%, even more preferably about 60%. Further, it is believed that the less feedback of the projection on the skin surface, such as a fingertip, provides a more comfortable feeling. For example, the less feedback of the projection, that is a larger surface area to touch the skin, is more comfortable; in contrast, the higher feedback of the projection, that is a smaller surface area or a shaper edge, to touch a skin is less comfortable.

### Test Procedure for Measuring Properties

Hardness

Hardness of materials is tested at room temperature and at 36 degrees Celsius using Shore A Durometer Instron Model 9130-35 (available from Instron, Norwood, Mass.) according to ASTM 2240-00.

Coefficient of Friction when Dry and when Wet

Coefficient of friction for each material to be tested is measured using a MTT175 tensile tester (available from Dia-stron Limited, Broomall, Pa.) in which a skin mimic preparation is dragged across the material to be tested. The coefficient of friction for each material is tested when dry, wet with water, or in the presence of various lubricious materials. To mimic skin, a polyurethane textured pad is prepared. Nonlimiting examples of skin mimic preparations and polyurethane textured pads are described in U.S. Patent Application Publication Nos. 2007/0128255 and 2009/0212454. A sled/probe is used in which the surface is polished stainless steel. The skin mimic is attached to the sled/probe surface via double-sided tape or clips. The material to be tested is attached to the stage below the sled/probe surface with preferably double-sided tape and optionally clips. If heat is used, the water bath to warm the platform of the MTT175 tester is set to 39+/−1 degrees Celsius and water is circulated. The sled/probe with the skin mimic is mounted to the floating parallelogram cradle of the tester, which is connected to a load cell. The angle of the sled/probe with the skin mimic is set so that the skin mimic surface is flat against the stage, which is attached to the material to be tested, with an approximate angle of about 35 degrees. The parallelogram cradle is leveled to be flat. Downward force can be adjusted by moving weights along a threaded shaft in which the downward force is adjusted to about 175 gm to about 230 gm. If lubricious materials are used, for example, shave preparations for illustrative purposes only, lather is generated by applying the shave preparation to the material to be tested, lathering by hand for about 30 seconds to about 60 seconds. For illustrative purposes only, about 2.5+/−0.7 grams of gel is applied and about 3.0+/−0.7 grams of foam is applied. A draw down bar can be used to level the surface of the shave preparation, set at about 2 mm, across the skin mimic Before performing the tests, the load cells are zeroed. To run the test measuring the coefficient of friction, software associated with the MTT175 tester is used and set at about 2000 gmf load cell with a displacement of about 60 mm and a speed of about 1500 mm/min at room temperature. Of the displacement, a smaller range of displacement is analyzed, such as about 110 mm to about 150 mm A force of about 226 g is applied in which the force is calibrated with a Mettler-Toldeo Balance Serial No. 114020837 (available from Mettler-Toledo, Inc., Columbus, Ohio). When measuring the coefficient of friction when wet, about 1 mL of room temperature tap water under the probe is used. About one to about three strokes are completed for each test and about three tests completed for each material. To perform another test, a new material is used. The skin mimic on the test head is washed with water and an alcohol wipe, then blotted dry with a paper towel. Alternatively, the skin mimic is replaced. The test head is dried before use.

To maximize reliability of data, at least three different operators perform the tests with a relative standard deviation of about less than 20% for the first stroke data over three separate tests—each operator over a period of three separate days. For each operator, the relative standard deviation is about less than 20%.

Tack

Tack information for each material is measured using a TA.XTPlus Texture Analyzer and its associated software (available from Texture Technologies Corporation, Scarsdale, N.Y.). Skin mimic, as prepared as described above, is attached to the round probe end of the Texture Analyzer instrument via double-sided tape and the material to be tested is attached to the metal stage of the Texture Analyzer instrument, which is below the Tack probe, via double-sided tape. The instrument is calibrated such that the height is set at 10 mm and the force is set using a 2000 g weight. Each cycle of testing includes probe contact with the material to be tested for about 5 seconds. The probe contact is then pulled away at about 5 mm/second. The probe contacts the material to be tested a second time for about 5 seconds and is then pulled away at about 1 mm/second. Optionally, to maximize good, repeatable contact of the probe with the material to be tested, the probe contacts the material for the second time after about a 5 second delay.

After a cycle of testing is complete, the skin mimic is washed with alcohol and is blotted dry with a paper towel. The material to be tested is replaced with a fresh, new material and repeated for a total of at least three cycles of sampling per material.

To maximize reliability of data, at least three different operators perform the tests with a relative standard deviation of about less than 50%, preferably about less than 20%, over three separate tests—each operator over a period of three separate days.

Surface Energy

Contact angle measurements is used to determine the surface energy of the materials to be tested in which the contact angle depends on the compatibility between the surface properties of the wetting liquid and the material to be tested. Surface energy is calculated from Young's equation in measures of energy per unit area (mJ/m²). Contact angle measurements utilize a Contact Angle and Surface Tension instrument (available from First Ten Angstroms, Portsmouth, Va.), such as FTA200, with FTA video 2.0 software in which the instrument includes a camera that can capture many frames per second, a pump to dispense drops from syringes, and a stage to place the sample while frames are collected. To set up the test, the lighting is adjusted so that there is a white background and a dark drop and the focus is adjusted.

The material to be tested is placed below the syringe and leveled. The syringe is filled with a first liquid such that no bubbles remain. The program is initiated and run such that the instrument drops the liquid and takes measurements of contact angle. Two solvents are used, specifically diiodomethane and water. Owens-Wendt regression analysis is conducted to obtain surface energy measurements based on these two solvents.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An oral care device, the device comprising:
a thermoplastic elastomer disposed on a portion of the oral care device; and
one or more projections extending from the thermoplastic elastomer, wherein the thermoplastic elastomer is polar and hydrophilic.

2. The oral care device of claim 1, wherein the one or more projections comprises at least two projections.

3. The oral care device of claim 2, wherein at least one groove is formed between the at least two projections.

4. The oral care device of claim 1, wherein the one or more projections are integrally formed with the thermoplastic elastomer.

5. The oral care device of claim 4, wherein the one or more projections are integrally formed with the thermoplastic elastomer by injection molding.

6. The oral care device of claim 5, wherein the one or more projections are integrally formed with the thermoplastic elastomer by two-step injection molding.

7. The oral care device of claim 1, wherein the portion of the oral care device is selected from the group consisting of a grip portion of the oral care device, a head portion of the oral care device, a cleaning portion of the oral care device, a massaging portion of the oral care device, and combinations thereof.

8. The oral care device of claim 7, wherein the grip portion comprises a thumb rest portion, an index ringer rest portion, and/or a third portion.

9. The oral care device of claim 1, wherein the thermoplastic elastomer is combined with a non-elastomer.

10. An oral care device comprising:
a thermoplastic elastomer disposed on a portion of the oral care device and the thermoplastic elastomer defining one or more pores to facilitate removal of water when wet.
wherein the thermoplastic elastomer is polar and hydrophilic.

11. The oral care device of claim 10 further comprising one or more projections extending from the thermoplastic elastomer.

12. The oral care device of claim 11, wherein the one or more projections is at least two projections.

13. The oral care device of claim 12 further comprising at least one groove formed between the at least two projections.

14. The oral care device of claim 11, wherein the one or more projections are integrally formed with the thermoplastic elastomer.

15. The oral care device of claim 14, wherein the one or more projections are integrally formed with the thermoplastic elastomer by injection molding.

16. The oral care device of claim 15, wherein the one or more projections are integrally formed with the thermoplastic elastomer by two-step injection molding.

17. The oral care device of claim 10, wherein the portion of the oral care device is selected from the group consisting of a grip portion of the oral care device, a head portion of the oral care device, a cleaning portion of the oral care device, a massaging portion of the oral care device, and combinations thereof.

18. The oral care device of claim 17, wherein the grip portion comprises a thumb rest portion, an index ringer rest portion, and/or a third portion.

19. The oral care device of claim 10, wherein the thermoplastic elastomer is combined with a non-elastomer.
